(19) United States
(12) Patent Application Publication
(10) Pub. No.: US 2007/0051877 A1
(43) Pub. Date: Mar. 8, 2007

(54) Optical transmitter-receiver, optical transmitter-receiver module, and optical communication device

(75) Inventors: Kazuhiro Sakai, Kanagawa (JP); Osamu Ohtani, Kanagawa (JP); Osamu Ueno, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/395,376

(22) Filed: Apr. 3, 2006

(30) Foreign Application Priority Data
Sep. 6, 2005 (JP) 2005-257581
Sep. 12, 2005 (JP) 2005-264082

(51) Int. Cl. H01J 40/14; G01J 1/44

(52) U.S. Cl. 250/214 R

(57) ABSTRACT

An optical transmitter-receiver includes: an optical module including a metal package housing at least a light receiving element and a light emitting element; a circuit board for transmitting/receiving an electric signal with respect to the optical module; a first wiring for connecting a side of the light receiving element to the circuit board; a second wiring for connecting a side of the light emitting element to the circuit board; and a shield member for shielding at least the first wiring.

### BACKGROUND OF THE INVENTION

1. Field of the Invention

The present invention relates to an optical transmitter-receiver for performing an interactive optical communication through an optical transmission medium by using an optical transmission-receiving module having a light emitting element and a light receiving element.

2. Description of the Related Art

The one-core interactive optical communication system using a single optical fiber has been developed. In such one-core interactive optical communication system, an optical transmitter-receiver having optical elements such as a light emitting element and a light receiving element, an optical waveguide for optically coupling the optical elements with an optical fiber and an amplifying IC, etc., is used. In order to popularize the one-core interactive optical communication system, the development of low cost optical transmitter-receiver is important and, for this reason, it is necessary to integrate the optical elements, the optical waveguide and the amplifying IC, etc., within one package.

However, when a light emitting element, which is driven with high speed large current, is arranged in the vicinity of a light receiving element, which receives very small light, and/or the amplifying IC, which amplifies very small current, electrical cross-talk occurs by electromagnetic noise due to current driving the light emitting element, resulting in degradation of light receiving sensitivity of the light receiving element.

In order to reduce the electrical cross-talk, a construction in which a light emitting element and a light receiving element are positioned in mutually remote locations (see, for example, JP-A-5-100132 and JP-A-2005-3860) and a construction in which a light receiving portion (light receiving element) or a light receiving portion and a light emitting portion (light emitting element) are covered by a shield member such as an electrically conductive resin or a metal mesh (see, for example, JP-A-11-271546 and JP-A-2000-228555) have been known.

Conventionally, an optical transmitter-receiver module having a light emitting element such as a light emitting diode (LED) or a surface emitting laser (VCSEL) and a light receiving element such as a photodiode (PD), for performing an interactive optical communication through an optical fiber has been known as a low cost optical transmission device. In such optical transmitter-receiver module, the reduction of cross-talk between a transmitting system and a receiving system is important in view of the reliability of transmission and various proposals have been made

The prior art disclosed in JP-B-03-063240 is a semiconductor device for optical communication, in which a grounding terminal on a light receiving side and a grounding terminal on a light emitting side, which are electrically separated from each other, are formed on a circuit board, the light receiving element, etc., is shielded by a first metal shield and the light emitting element, etc., are shielded by a second metal shield.

The prior art disclosed in JP-A-2003-264471 is an optical transmitter-receiver module in which a shielding wall is disposed between grounding layers in a circuit board on which a transmitting circuit and a receiving circuit are mounted.

The prior art disclosed in JP-A-05-335617 is an optical transmission module in which a transmitting system and a receiving system are electrically separated by providing a light receiving element module on one of surfaces of a double-surface printed circuit board and a light emitting element module on the other surface thereof.

On the other hand, an optical transmitter-receiver module in which a light emitting element and a light receiving element are housed in one package has been known (see, for example, JP-A-2003-329892).

However, in the related art disclosed in JP-A-5-100132 and JP-A-2005-3860, in which the light emitting element and the light receiving element are positioned in mutually remote locations, it is difficult to reduce the size and/or to integrate the constructive elements. In the related art disclosed in JP-A-11-271546 and JP-A-2000-228555, it is difficult to reduce electrical cross-talk generated in a wiring portion between an optical module and a circuit board since only shield is provided within the optical module.

In the structures disclosed in JP-B-03-063240 and JP-A-2003-264471, in which one of the transmitting system and the receiving system is shielded or both of the transmitting system and the receiving system are shielded separately, the structure disclosed in JP-A-05-335617, in which the transmitting system and the receiving system are mounted on the respective surfaces of the printed circuit board, the light emitting element is provided in a position remote from a position, in which the light receiving element is provided. Therefore, when an interactive communication is performed through a single optical fiber, there is a problem that the size of an optical coupling portion, which is optically coupled to the optical fiber, becomes large.

Further, when the transmitting system and the receiving system are separated within the circuit board by the grounding layer as disclosed in JP-A-2003-264471, there is a problem that a conductive pattern becomes complicated.

Though it is possible to reduce the size of the optical coupling portion for optically coupling the optical fiber by the structure disclosed in JP-A-2003-329892, noise and/or EMI (electromagnetic interference) tends to occur since pins for the transmitting system and the receiving system exist alongside each other.

The present invention provides an optical transmitter-receiver capable of reducing electrical cross-talk generated by a wiring portion between an optical module and a circuit board, while reducing the size and cost thereof.

Also, the present invention provides an optical transmitter-receiver module and an optical communication device, which is compact and capable of reducing cross-talk without using complicated conductive patterns.

### SUMMARY OF THE INVENTION

According to an aspect of the invention, there is provided, an optical transmitter-receiver having: an optical module including a metal package housing at least a light receiving element and a light emitting element; a circuit board for transmitting/receiving an electric signal with respect to the optical module; a first wiring for connecting a side of the light receiving element to the circuit board; a second wiring for connecting a side of the light emitting element to the circuit board; and a shield member for shielding at least the first wiring.

According to the above mentioned optical transmitter-receiver, the second wiring generates electromagnetic wave when a high frequency signal is transmitted from the circuit board to the light emitting element. By shielding the first wiring with the shield member formed of such as metal, the electromagnetic wave generated by the second wiring is prevented from reaching the first wiring. Therefore, it becomes possible to prevent the output signal of the light receiving element, which is transmitted through the first wiring, from being disturbed by electromagnetic wave generated in the second wiring and it is hardly influenced by electrical cross-talk due to electromagnetic wave from the side of the light emitting element. The shield member is formed of a metal such as, for example, copper or aluminum and may have a plate, foil or mesh form.

According to the present invention, it is possible to reduce electrical cross-talk generated from the wiring between the optical module and the circuit board while reducing size and cost of the optical transmitter-receiver.

According to another aspect of the present invention, there is provided an optical transmitter-receiver module including: a package housing a light emitting element and a light receiving element; and at least three terminals led out from the package, wherein terminals among the at least three terminals, which are related to the light receiving element and the light emitting element, are provided in different regions through linear split lines.

According to the above mentioned optical transmitter-receiver module, cross-talk between the transmitting side and the receiving side hardly occurs compared with the case where the terminals exist alongside each other, since the terminals related to the light emitting element and the light receiving element are provided in the different regions through the linear split lines. Further, since the light emitting element and the light receiving element are housed in the package, the downsizing of the optical coupling portion such as an optical waveguide for connecting the module to an optical fiber becomes possible.

The terminals related to the light emitting element include a signal terminal for driving the light emitting element, a signal terminal for driving a drive IC for driving the light emitting element and a grounding terminal and the terminals related to the light receiving element include a signal terminal for deriving an output signal of the light receiving element, a signal terminal for deriving an output signal of an amplifying IC for amplifying the output signal of the light receiving element and a grounding terminal. Incidentally, there may be a case where a power source terminal for the amplifying IC is not included in the terminals related to the light emitting element.

The at least three terminals may be a combination of at least one terminal related to the light emitting element and at least two terminals related to the light receiving element or a combination of at least two terminals related to the light emitting element and at least one terminal related to the light receiving element. Configuration of these terminals is arbitrary. The terminals may take in the form such as rod, plate and/or thin film.

According to still another aspect of the present invention, there is provided an optical communication device including an optical transmitter-receiver module having a package housing a light emitting element and a light receiving element and at least three terminals led out from the package, which the terminals related to the light emitting element and the light receiving element are provided in different regions through linear split lines, and a circuit board including a substrate formed of an insulating material, a first conductive pattern formed on a first surface of the substrate and a second conductive pattern formed on a second surface of the base member opposite to the first surface. The optical transmitter-receiver module is mounted on the circuit board to cover a side surface portion thereof, the terminals related to the light emitting element are connected to one of the first and second conductive patterns and the terminals related to the light receiving element are connected to the other of the first and second conductive patterns.

According to the above optical communication device, it is possible to reduce cross-talk between the transmitting side and the receiving side since the circuit board exists between the terminals related to the light emitting element and the terminals related to the light receiving element. Further, downsizing of the device can be realized by mounting the optical transmitter-receiver module on the side surface portion of the circuit board.

According to the present invention, it is possible to provide an optical transmitter-receiver module and an optical communication device, which are capable of reducing the size and reducing cross-talk without making the conductive patterns complicated.

### BRIEF DESCRIPTION OF THE DRAWINGS

Embodiments of the present invention will be described in detail based on the following figures, wherein:

FIGS. 1A and 1B show an optical transmitter-receiver according to a first embodiment of the present invention, in which FIG. 1A is a plan view thereof and FIG. 1B is a sectional view taken along a line A-A in FIG. 1A;

FIG. 2 is a plan view of an optical module according to the first embodiment, showing a detailed construction thereof;

FIG. 3 is a plan view of a sub mount shown in FIG. 1;

FIGS. 4A and 4B show an optical transmitter-receiver according to a second embodiment of the present invention, in which FIG. 4A is a plan view thereof and FIG. 4B is a sectional view taken along a line B-B in FIG. 4A;

FIGS. 5A and 5B show an optical transmitter-receiver according to a third embodiment of the present invention, in which FIG. 5A is a plan view thereof and FIG. 5B is a side view thereof;

FIGS. 6A and 6B show a flexible board according to the third embodiment, in which FIG. 6A is a plan view thereof and FIG. 6B is a sectional view taken along a line C-C in FIG. 6A;

FIG. 7 is a plan view of an optical transmitter-receiver module according to a fourth embodiment of the present invention;

FIG. 8 is a cross sectional view taken along a line A-A in FIG. 7;

FIG. 9 is a plan view of a sub mount according to the fourth embodiment of the present invention;

FIGS. 10A and 10B show an optical communication device according to a fifth embodiment of the present invention, in which FIG. 10A is a front view thereof and FIG. 10B is a plan view thereof;

FIG. 11 is a plan view of an optical transmitter-receiver module according to a sixth embodiment of the present invention;

FIG. 12 is a partial cross sectional view showing a structure of a stem according to the sixth embodiment of the present invention;

FIG. 13 is a plan view of a sub mount according to the sixth embodiment of the present invention;

FIG. 14 is a plan view of an optical transmitter-receiver module according to a seventh embodiment of the present invention;

FIG. 15 is a partial cross sectional view showing an optical communication device in which the optical transmitter-receiver module according to the seventh embodiment of the present invention is mounted on a circuit board;

FIG. 16 is a plan view showing an optical transmitter-receiver module according to an eighth embodiment of the present invention; and

FIG. 17 is a partial cross sectional view showing an optical communication device in which the optical transmitter-receiver module according to the eighth embodiment of the present invention is mounted on a circuit board.

### DETAILED DESCRIPTION OF THE INVENTION

### First Embodiment

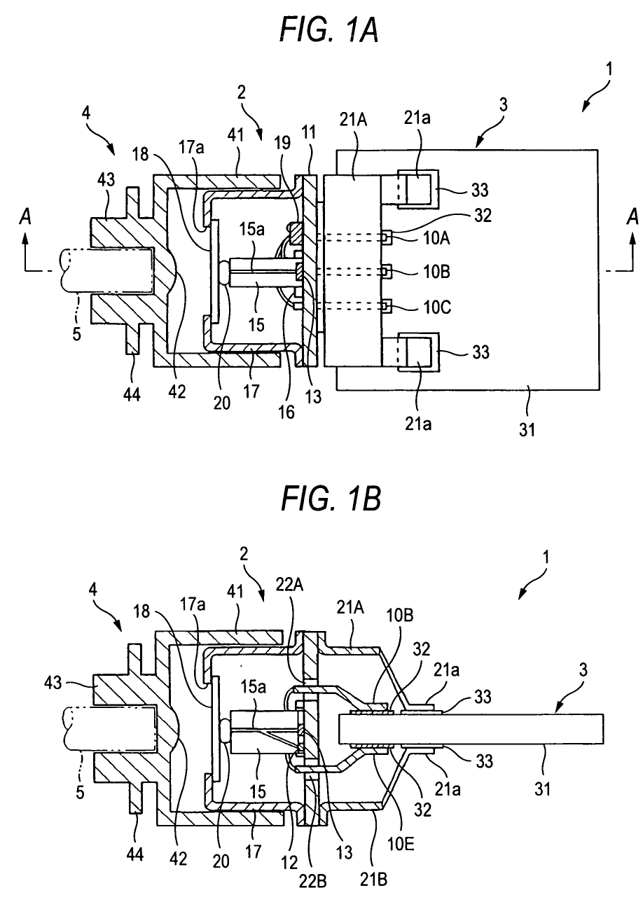

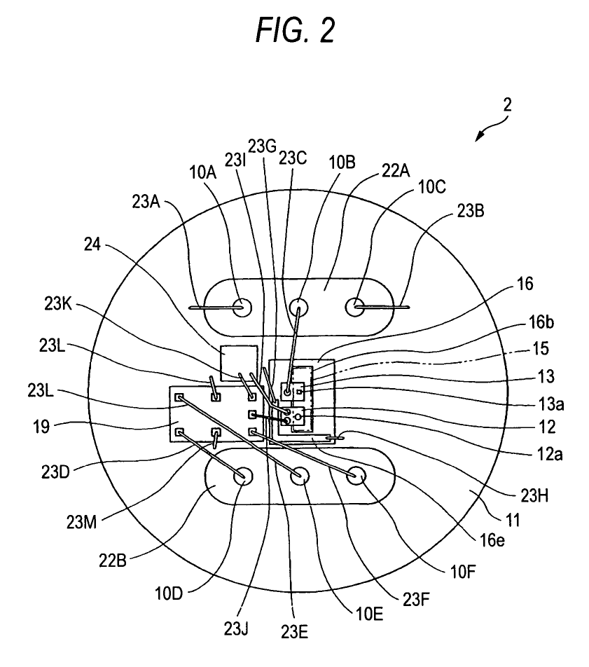

FIGS. 1A and 1B show an optical transmitter-receiver according to a first embodiment of the present invention, in which FIG. 1A is a plan view thereof and FIG. 1B is a cross sectional view taken along a line A-A in FIG. 1A. FIG. 2 shows a detailed construction of the optical module shown in FIG. 1. Incidentally, a cross section of the optical module is shown in FIG. 1A. FIG. 2 shows mounting parts on a stem and an optical waveguide is shown by imaginary chain lines.

The optical transmitter-receiver 1 includes a CAN package type optical module 2 to which an optical fiber 5 as an optical transmission medium is connected through a coupler member 4, a circuit board 3 mounting the optical module 2 thereon and transmitting/receiving an electric signal with respect to the optical module 2 and shield members 21A and 21B provided on the circuit board 3, for shielding electrode pins 10 (10A to 10F) as a wiring portion of the optical module 2.

The optical module 2 includes a stem 11 having pin holding portions 22A and 22B, which hold the electrode pins 10, a light receiving element 12 and a light emitting element 13 arranged on the stem 11, an optical waveguide 15 for optically coupling a light receiving portion 12a of the light receiving element 12 and a light emitting portion 13a of the light emitting element 13, a sub mount 16 for positioning the light receiving element 12, the light emitting element 13 and the optical waveguide 15, an amplifier 19 provided on the stem 11, for amplifying an output signal of the light receiving element 12 and a capacitor 24.

Further, the optical module 2 includes a metal cap 17 having an opening 17a in a ceiling thereof, for sealing the members on the stem 11, a transparent window 18 for sealing the opening 17a and a refractive index matching agent 20 provided between the transparent window 18 and the optical waveguide 15. A metal package is formed by the combination of the cap 17 and the stem 11.

The circuit board 3 includes a base member 31 formed of an insulating material such as epoxy resin, solder pads 32 formed on both surfaces of the base member 31 and connected to the electrode pins 10A to 10F of the optical module 2 and solder pads 33 formed on the both surfaces of the base member 31 and connected to shield members 21A and 21B and to ground. Further, on the circuit board 3, wiring patterns (not shown) connected to the solder pads 32 and 33 and electronic parts such as a drive circuit of the light emitting element 13 and an amplifier for further amplifying an output of the amplifier 19 are mounted.

The coupler member 4 is formed by, for example, molding of transparent resin material and mounted on the cap 17. The coupler member 4 includes a housing portion 41 fitted on the cap 17, a lens portion 42 formed in a center within the housing portion 41, an optical fiber insertion portion 43 formed in an upper portion of the housing portion 41 and having a cylindrical shape into which the optical fiber 5 is inserted and a collar portion 44 provided an outer periphery of the optical fiber insertion portion 43.

There is a predetermined gap provided between a lower end surface of the housing portion 41 and an upper face of the peripheral portion of the cap 17. With such gap, the coupler member 4 can be finely regulated vertically and laterally, so that a focus point regulation of the lens portion 42 becomes possible.

Among the electrode pins 10A to 10F, the electrode pins 10A to 10C are used as a second wiring for transmission, in which the electrode pin 10B is for drive signal and the electrode pins 10A and 10C are for the grounding (GND). The electrode pins 10D to 10F constitute a first wiring for receiving, in which the electrode pin 10D and 10E are for differential signal output, and the electrode pin 10F is used for power supply for the amplifier. The electrode pins 10A to 10F are connected to the surface of the stem 11 and the terminals of, the light receiving element 12, the light emitting element 13 and the amplifier 19, by bonding wires 23A to 23M.

The stem 11 takes in the form of a metal disc of copper or copper alloy so that the wire bonding to the surface thereof is possible. Pin holding portions 22A and 22B are separated from each other by a predetermined distance and buried in the stem 11.

The light receiving element 12 having an upper surface on which a light receiving portion 12a is provided for receiving an optical signal, a lower surface with which the light receiving element 12 is mounted on the stem 11 is a surface type optical element having two electrodes on the upper surface thereof. The light receiving element 12 may be GaAs PIN photodiode.

The light emitting element 13 having an upper surface, on which a light emitting portion 13a is provided for emitting an optical signal, a lower surface, with which the light receiving element 13 is mounted on the stem 11, is a surface type optical element having two electrodes on the upper and lower surfaces, respectively. The light emitting element 13 may be a VCSEL having wavelength of 850 nm. A light emitting element having two electrodes on the upper surface thereof may be used.

The optical waveguide 15 is, for example, a high molecular optical waveguide, which is constructed with a core member of such as acrylic resin, epoxy resin or polyimide resin and in which a branched light guide portion 15a having an inverted Y shape is formed, and a clad formed of such as fluoropolymer having refractive index smaller than that of the core and surrounding the light guide portion 15a. Such optical waveguide 15 may be fabricated as disclosed in, for example, JP-A-2004-226941. That is, the high molecular optical waveguide is fabricated by filling a recessed portion formed in a surface of a hardened resin mold with a core forming resin such as thermosetting or ultraviolet-ray setting resin, attaching a clad forming film to a surface of the mold, setting the core forming resin, removing the hardened core forming resin from the mold and forming a clad layer on the side of a core forming surface of the clad forming film. Incidentally, the pattern of the light guide portion 15a is not limited to the inverted Y shape and other patterns such as Y shape according to a combination of the optical elements.

In order to reduce external noise, the cap 17 takes in the form of a metal canister of such as copper or copper alloy.

The transparent window 18 prevents immigration of dust into the cap 17 and is formed from a transparent material such as a plastic material such as polymethyl methacrylate, polycarbonate or amorphous polyolefin or inorganic glass.

The amplifier 19 is a TIA (Trans Impedance Amplifier) having low noise characteristics and wide band characteristics. For example, the amplifier 19 for amplifying the output current of the light receiving element 12 has a circuit construction of an NFB (Negative Feedback) inverting amplifier using a high speed low noise differential amplifier. In order to improve anti-noise characteristics, amplification of the output of the light receiving element 12 is performed in two steps. The amplifier 19 takes over the first step and an amplifier taking the second step amplifies voltage signal from the amplifier 19 and is mounted on the side of the circuit board 3. The amplifier used in the second step may be provided on the side of the optical module 2.

The refractive index matching agent 20 is formed of a transparent material having refractive index similar to that of the optical waveguide 15 as well as the transparent window 18. For example, the refractive index matching agent 20 may be formed of silicone resin or ultraviolet-ray setting adhesive.

The shield members 21A and 21B are formed from rectangular plates of metal such as copper having high shielding characteristics and high soldering characteristics and are arranged in parallel opposing to each other. Each of the shield members 21A and 21B has a pair of connecting pieces 21a extending from one edge of the shield member. In order to prevent the shield members 21A and 21B from being deformed, it is preferable that the rigidity of these shield members are high. Incidentally, though the pair of the shield members are preferably, it may be possible to remove the transmitting side shield member 21A.

The pin holding portions 22A and 22B are formed of an insulating material such as synthetic resin or glass and have elliptic shapes. Three electrode pins 10A to 10C are provided on the pin holding portion 22A at equal intervals and three electrode pins 10D to 10F are provided on the pin holding portion 22B at equal intervals.

The capacitor 24 is used to stabilize reverse bias potential applied to the light receiving element 12 and has two electrodes on an upper surface thereof.

(Construction of the Sub Mount)

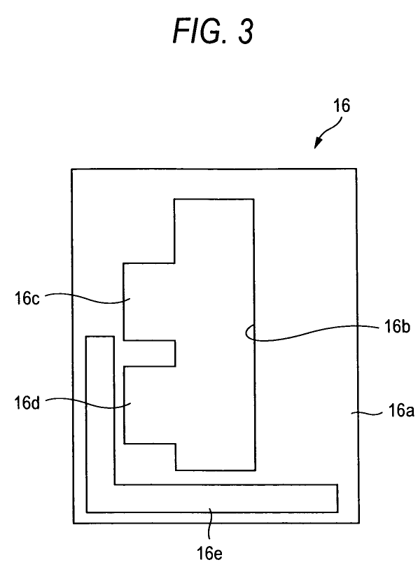

FIG. 3 shows a construction of the sub mount. The sub mount 16 includes a body 16a formed of an insulating material such as Si, a through-hole 16b provided in a center portion of the body 16a and having a shape corresponding to the optical waveguide 15 mounted on the light receiving element 12 and the light emitting element 13, which are arranged in predetermined positions, a light emitting element mounting portion 16c provided in one side of the through-hole 16b, for positioning the light emitting element 13, a light receiving element mounting portion 16d provided in the through-hole 16b adjacent to the light emitting element mounting portion 16c, for positioning the light receiving element 12 and an L shaped metal pattern 16e provided in a corner portion in the vicinity of the light receiving element mounting portion 16d as an impedance reducing member.

The metal pattern 16e is coated with an insulating film in order to prevent the bonding wires 23F and 23J passing over the metal pattern 16e from contacting with the metal pattern 16e.

(Assembling of the Optical Transmitter-Receiver)

Now, an example of the assembling method of the optical transmitter-receiver 1 will be described. First, the optical module 2 is fabricated. The sub mount 16, the amplifier 19 and the capacitor 24 are positioned in predetermined positions on the stem 11 having the pin holding portions 22A and 22B for holding the electrode pins 10A to 10F. Then, the light emitting element 13 and the light receiving element 12 are positioned and fixed in the light emitting element mounting portion 16c and the light receiving element mounting portion 16d of the sub mount 16. In this case, the bottom surface of the light emitting element 13 is in contact with the upper surface of the stem 11 and grounded through the stem.

Next, the electrode pins 10A and 10C are connected to the surface of the stem 11 by bonding wires 23A and 23B, respectively, and the opposite end portions of the metal pattern 16e are connected to the surface of the stem 11 by bonding wires 23G and 23H, respectively. Further, the amplifier 19 is connected to the surface of the stem 11 by bonding wires 23L and 23M, respectively, and the electrode pin 10B is connected to the electrode of the light emitting element 13 by a bonding wire 23C.

The amplifier 19 is connected to the electrode pins 10D, 10E and 10F by bonding wires 23D, 23E and 23F and the amplifier 19 is connected to one electrodes of the light receiving element 12 and the capacitor 24 by bonding wires 23K and 23J and the other electrodes of the light receiving element 12 and the capacitor 24 are connected each other by a bonding wire 23I.

Next, the optical waveguide 15 is positioned and fixed in the through-hole 16b of the sub mount 16 such that the lower end of the light guide portion 15a is optically coupled with the light receiving portion 12a and the light emitting portion 13a. Further, the refractive index matching agent 20 is put on the light guide portion 15a. In this state, the cap 17 having the transparent window 18 attached thereto is fixed onto the stem 11 by electrically conductive adhesive.

Thereafter, the electrode pins 10A to 10F of the optical module 2 thus fabricated are bent inward such that a distance between the electrode pin lines corresponds to the thickness of the circuit board 3. The optical module 2 is put horizontally with the side of the electrode pins 10A to 10C being up, the circuit board 3 is positioned between the pin lines and the optical module 2 is mounted on the circuit board 3 such that the optical module 2 covers a side surface portion of the circuit board 3. Next, the top ends of the electrode pins 10A to 10F are soldered to solder pads 32 provided on both surfaces of the circuit board 3. Further, the upper end portions of the shield members 21A and 21B are soldered to the surface of the stem 11 of the optical module 2 and the paired connecting pieces 21a are soldered to the solder pads 33 of the circuit board 3.

Next, the housing portion 41 of the coupler member 4 is fitted in the cap 17, the optical fiber 5 is inserted and held in the optical fiber insertion portion 43. After the coupler member 4 is positioned, the housing portion 41 is fixed in the cap 17 by such as epoxy resin.

(Operation of the Optical Transmitter-Receiver)

Now, an operation of the optical transmitter-receiver will be described. When an optical signal is transmitted from the optical fiber 5, the signal is guided to the light guide portion 15a of the optical waveguide 15 through the lens portion 42 of the coupler member 4, the transparent window 18 and the refractive index matching agent 20. The optical signal from the light guide portion 15a is guided to the light receiving portion 12a of the light receiving element 12 and converted into an electric signal by the light receiving element 12. The electric signal becomes differential signals obtained by current-voltage conversion by the amplifier 19 and the differential signals are outputted to the circuit board 3 through the electrode pins 10D and 10E. The circuit board 3 receives the differential signals from the optical module 2 through the solder pads 32 and the voltage amplification is performed by an amplifier (not shown) mounted on the circuit board 3.

On the other hand, the drive signal from a drive circuit (not shown) mounted on the circuit board 3 is inputted to the electrode pin 10B through the solder pad 32 to drive the light emitting element 13. An optical signal outputted from the light emitting portion 13a of the light emitting element 13 is inputted to the refractive index matching agent 20 through the light guide portion 15a of the optical waveguide 15 and further to the optical fiber 5 through the transparent window 18 and the lens portion 42. Thus, the one core interactive communication is performed through the optical fiber 4.

### Advantage of the First Embodiment

According to the first embodiment, the following advantages are obtained.

(a) Since the shield members 21A and 21B are provided to cover the electrode pins 10A to 10F and are grounded, it is possible to reduce electrical cross-talk due to electromagnetic wave on the sending side to thereby reduce electromagnetic noise on the receiving side. That is, electromagnetic wave is generated in the transmitting side wiring portion including the electrode pin 10B by the drive signal applied to the light emitting element 13. Though the electrode pins 10A to 10F are arranged on both the transmitting side and the receiving side, a large current flows by the drive signal. Therefore, electromagnetic wave generated in the electrode pin 10B propagates up to the setting positions of the receiving electrode pins 10D and 10E, so that noise is induced in the electrode pins 10D and 10E. However, since the influence of inductance component of the electrode pins 10A to 10F can be removed by the shield members 21A and 21B, the problem of the electromagnetic wave can be solved. Particularly, since the closer the distance between the shield members 21A and 21B and the electrode pins 10A to 10F is the smaller the inductance component of the electrode pins 10A to 10F, the effect of reduction of the inductance component becomes conspicuous.

(b) The shield is provided by arranging the metal pattern 16e, which extends in parallel to the bonding wire 23E, between the light receiving element 12 and the amplifier 19 so that an impedance of the input portion of the amplifier 19, to which a very small current flows, can be reduced, so that it is possible to reduce electrical cross-talk.

(c) Since the electrode pins 10D to 10F connected to the amplifier 19 are arranged in a line different from the line of the transmitting electrode pins 10A to 10C and separated from the transmitting side, electrical cross-talk hardly occurs.

(d) Since the transmitting side electrode pins 10A to 10C are separated from the receiving side electrode pins 10D to 10F by the circuit board 3, it is possible to reduce electrical cross-talk through the circuit board 3.

(e) Since only the shield members 21A and 21B are added, it is possible to reduce the size and cost of the optical transmitter-receiver 1.

Incidentally, in the first embodiment, though the side of the shield members 21A and 21B, which is close to the optical module 2, are connected to the stem 11, it may be possible to connect the side of the shield members to not the stem 11 but the cap 17.

### Second Embodiment

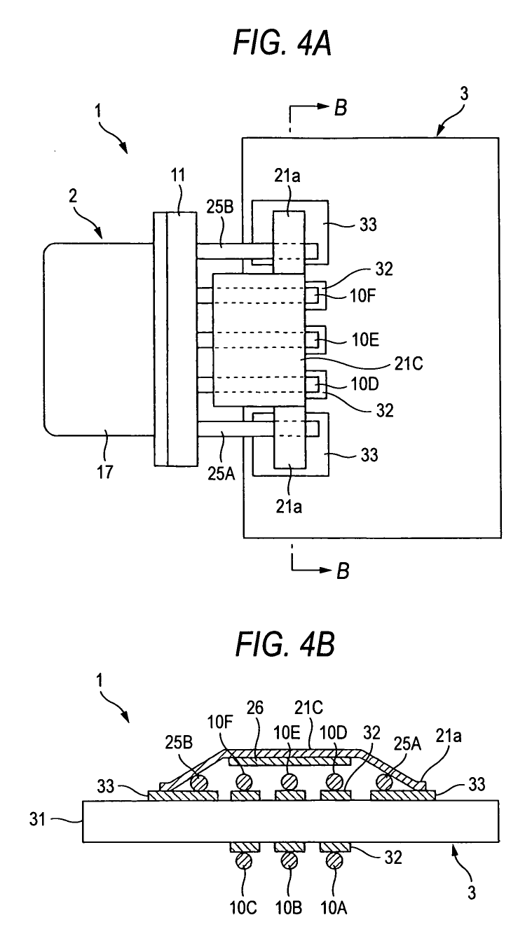

FIGS. 4A and 4B show an optical transmitter-receiver according to the second embodiment of the present invention, in which FIG. 4A is a bottom view thereof and FIG. 4B is a cross section taken along a line B-B in FIG. 4A.

The second embodiment differs from the first embodiment in that the shield member 21B on the receiving side is replaced by a shield member 21C having lower rigidity, the transmitting side shield member 21A is removed, grounding electrode pins 25A and 25B are provided in the vicinity of the opposite sides of the receiving side electrode pins 10D to 10F and the grounding electrode pins 25A and 25B are connected to the solder pads 33. The other configurations are similar to those of the first embodiment.

The shield member 21C may be formed from, for example, a copper foil having low rigidity and covers the electrode pins 10D to 10F. Connecting pieces 21a to be connected to the solder pads 33 extend from both sides of the shield member 21C.

Since the rigidity of the shield member 21C is low, there is a possibility that the shield member 21C contacts with the electrode pins 10D to 10F. In order to avoid such possibility, a sheet-like insulating member 26 is arranged between the electrode pins 10D to 10F and the shield member 21C. The insulating sheet member 26 may be a resin sheet formed of such as fluororesin.

The specifications of the grounding electrode pins 25A and 25B are the same as those of the electrode pins 10D to 10F and the grounding electrode pins 25A and 25B are mechanically and electrically fixed to the stem 11 directly so that the electrode pins 25A and 25B and the stem 11 become equipotential.

### Advantage of the Second Embodiment

According to the second embodiment, the effect, which is the same as that of the first embodiment, can be obtained even when the low rigidity shield member 21C is used. Further, since it is possible to arrange the shield member 21C in the vicinity of the electrode pins 10A to 10F, it is possible to reduce the height of the wiring portion, so that it is possible to reduce the size and weight of the optical transmitter-receiver 1.

Incidentally, in the second embodiment, the shield member 21C is provided on only the receiving side. However, it is possible to further provide a shield member 21C on the transmitting side.

### Third Embodiment

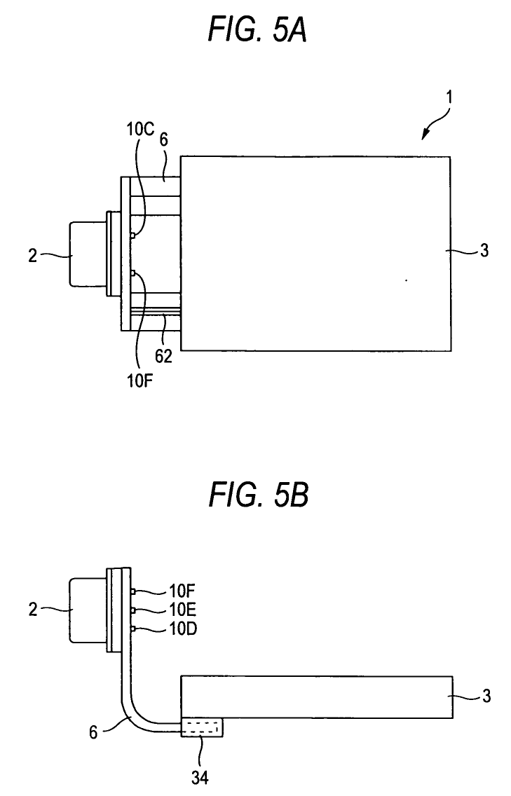

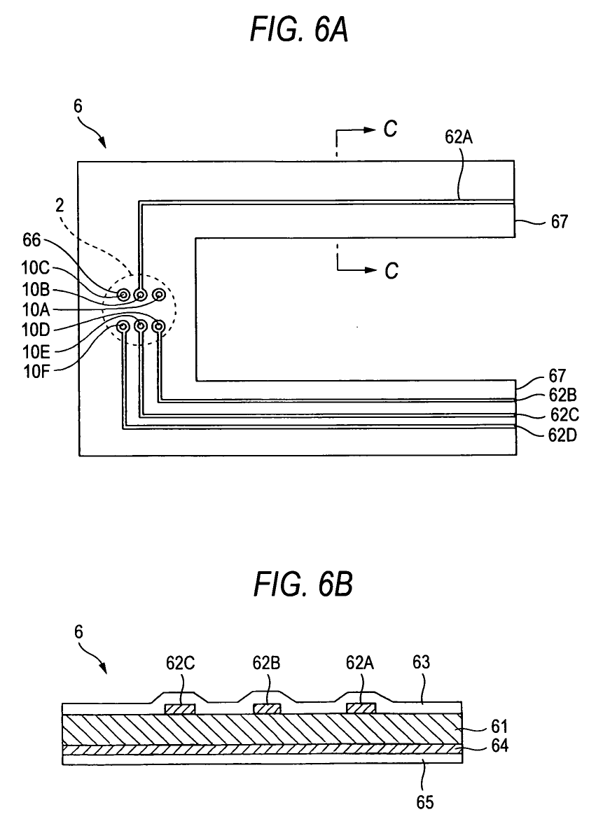

FIGS. 5A and 5B show an optical transmitter-receiver according to the third embodiment of the present invention, in which FIG. 5A is a plan view thereof and FIG. 5B is a side view thereof. FIGS. 6A and 6B are development of a flexible circuit board on which the optical module is mounted, in which FIG. 6A is a plan view and FIG. 6B is a cross section taken along a line C-C in FIG. 6A.

The optical transmitter-receiver 1 according to the third embodiment includes the optical module 2 and the circuit board 3 of the first embodiment and a flexible circuit board 6 connecting the optical module 2 to the circuit board 3. The construction of the optical module 2 is similar to the first embodiment shown in FIGS. 1A, 1B and 2. In the third embodiment, however, the electrode pins 10A to 10F are shortened compared with the first embodiment since these are mounted on the thin flexible circuit board 6.

As shown in FIG. 5B, the circuit board 3 has a connector 34 for connecting the flexible circuit board 6. Though the connector 34 is provided on a lower surface of the circuit board 3, it may be provided on the upper surface of the circuit board 3. Alternatively, other construction having no connector may be employed.

As shown in FIGS. 6A and 6B, the flexible circuit board 6 includes a base member 61 formed by a flexible insulating sheet having a fallen C shape, a plurality of electrically conductive patterns 62A to 62D, an insulator layer 63 for protecting a pattern forming surface of the base member board 61, a shield layer 64 of copper foil formed on a rear surface of the base member 61 and an insulator layer 65 for protecting the shield layer 64.

The conductive pattern 62A is used for drive signal and the conductive patterns 62B to 62D are used for signal receiving. The conductive patterns 62B and 62C are used for differential signals and the conductive pattern 62D is used for power supply to an amplifier. The shield layer 64 is also used for grounding (GND) of the optical module 2.

Solder pads 66 connected to the electrode pins 10A to 10F of the optical module 2 are provided at inside ends of the conductive patterns 62A to 62D, respectively, and through-holes for receiving the electrode pins 10A to 10F are formed at centers of the solder pads 66, respectively. In order to prevent electrical cross-talk, the transmitting side and receiving side conductive patterns 62A to 62D extending from the solder pads 66 are led out in different directions. Predetermined portions of the opposite ends of each of the conductive patterns 62A to 62D have no insulator layers 63 and are gold-plated to allow contact with electrodes within the connector 34 of the circuit board 3.

The connection between the optical module 2, the flexible circuit board 6 and the circuit board 3 is achieved by inserting the electrode pins 10A to 10F of the optical module 2 into the through-holes of the solder pads 66 of the flexible board 6 and soldering the electrode pins 10A to 10F to the solder pads 66. Then, as shown in FIG. 6A, the connecting ends 67 of the flexible circuit board 6 having the optical module 2 mounted thereon are inserted into slots of the connector 34 of the circuit board 3. Thereafter, the flexible circuit board 6 is bent at a right angle, resulting in the state shown in FIG. 5B.

### Advantage of the Third Embodiment

According to the third embodiment, the following effects can be obtained.

(a) Since the transmitting side wiring portion and the receiving side wiring portion are separated by the C shaped flexible circuit board 6 to spatially shielding the wirings for transmission signal and the receiving signal separately, it is possible to reduce electric cross-talk in the wiring portions.

(b) Since the electrode pins 10A to 10F of the optical module 2 are shortened, it is possible to reduce electric cross-talk in the electrode pins 10A to 10F.

(c) By using the optical module 2 shown in FIG. 2, which has the metal pattern 16e, electric cross-talk can be further improved.

(d) Since only the flexible circuit board 3 is added, it is possible to reduce the size and cost of the optical transmitter-receiver 1.

(e) By the use of the flexible circuit board 6 for the wiring portions, it is possible to arrange the optical module 2 remote from the circuit board 3, so that the design freedom of the optical transmitter-receiver 1 is improved.

(f) Since the flexible circuit board 6 has the microstrip line structure in which the conductive patterns 62A to 62D for transmitting signals are formed on one surface of the substrate 61 and the shield layer 64 is formed of the other surface of the substrate 61, inter-pattern interference is reduced and electric cross-talk can be reduced.

Incidentally, in the third embodiment, the flexible circuit board 6 may be formed such that the shield layer 64 covers the conductive patterns 62A to 62D. In such case, the shielding effect can be improved.

### Other Embodiments

Incidentally, the present invention is not limited to the described embodiments. The described embodiments may be variously modified within the scope of the present invention. Further, the constructive components of the described embodiments may be arbitrarily combined within the scope of the present invention.

As was described, according to an aspect of the shield member may have a construction, which shields the first wiring and the second wiring, separately. By shielding the second wiring, it is possible to prevent electromagnetic wave from leaking and, by further shielding the first wiring, the influence of electrical cross-talk due to electromagnetic wave from the side of the second wiring is further reduced.

The optical module may house an amplifier for amplifying the output signal of the light receiving element and the first wiring may connect the amplifier to the circuit board. The output signal of the light receiving element, which is amplified by the amplifier, tends to pick up noise. However, the electrical cross-talk can be prevented by shielding an output side of the amplifier.

The first and second wirings may be the light emitting element side electrode pin and the light receiving element side electrode pin, which are led out from the metal package, respectively.

The optical module is mounted on a side surface portion of the circuit board and the light emitting element side electrode pin and the light receiving element side electrode pin may be connected to electrical conductive patterns formed on the opposite surfaces of the circuit board, respectively.

The shield member may be connected to the metal package and a grounding pad provided on the circuit board and covers the wirings.

The shield member may be a metal sheet. By using a metal plate having some rigidity as the shield member, it is possible to provide a space with respect to the wiring to thereby prevent the wirings from contacting with the metal plate.

The shield member may be a metal foil formed between the wirings through an insulating member. It is possible to shield the wirings through the insulating member by such metal foil having no practical rigidity.

The metal package of the optical module may include a grounding electrode pin connected to the grounding pad provided on the circuit board and the metal foil may be connected to the grounding electrode pin.

The optical module may include an amplifier for amplifying an output signal of the light receiving element, the light receiving element is positioned by a sub mount formed of an insulating material, the amplifier is connected to the light receiving element through a bonding wire and the sub mount may include an impedance reducing member provided below the bonding wire. It is possible to reduce impedance of an input side of the amplifier by the impedance reducing member to thereby reduce the influence of electrical cross talk.

The impedance reducing member may be a metal member grounded by the metal package and having insulated surfaces. A flexible circuit board may be used as the first and second wirings. In such case, the freedom of layout is improved.

A conductive pattern on the side of the light receiving element and a conductive pattern on the side of the light emitting element of the flexible circuit board may be led out from the optical module in different directions. By separating the conductive pattern on the light receiving element from the conductive pattern on the side of the light emitting element, it is possible to restrict cross-talk.

The flexible circuit board may have a microstrip line structure. Since the signal line and the grounding pattern are arranged through the substrate, it is possible to reduce electrical cross-talk.

### Fourth Embodiment

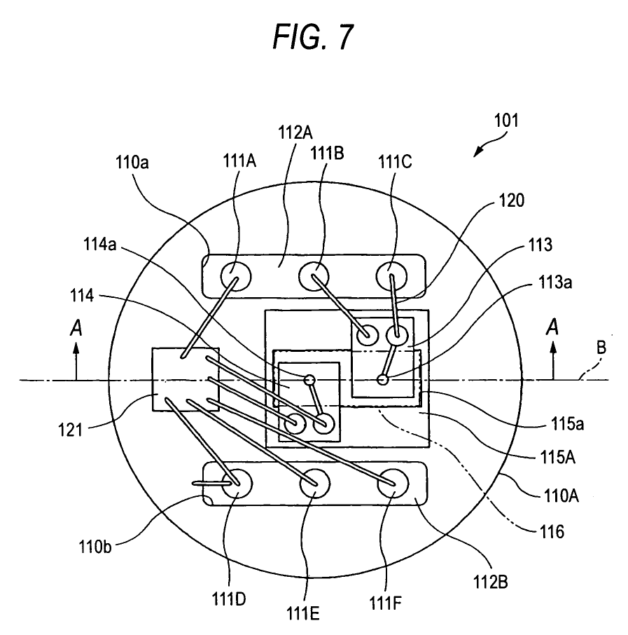

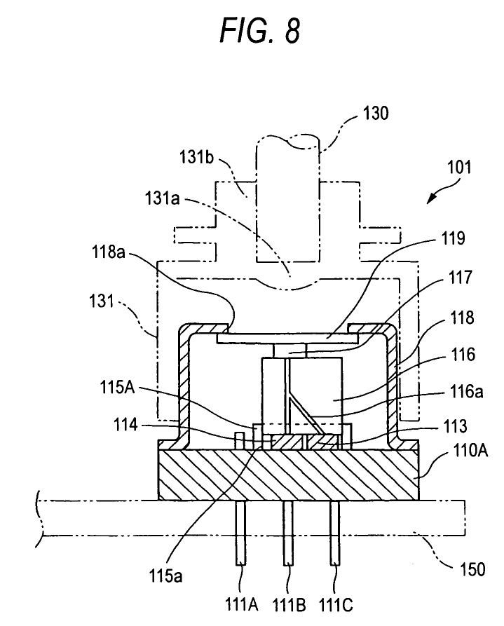

FIG. 7 shows an optical transmitter-receiver module according to a fourth embodiment of the present invention and FIG. 8 is a cross sectional view taken along a line A-A in FIG. 7. Incidentally, parts above a light emitting element and a light receiving element are removed in FIG. 7.

The optical transmitter-receiver module 101 includes a metal stem 110A taking a circular disc shape having a pair of through-holes 110a and 110b. Electrode pins 111A to 111C of a transmitting system and electrode pins 111D to 111F of a receiving system are provided in different regions of the stem divided by a linear dividing line B, that is, in the through-holes 110a and 110b through pin holding portions 112A and 112B formed of an insulating material, respectively. A distance between the electrode pins 111A to 111C of the transmitting system and the electrode pins 111D to 111F of the receiving system is larger than an interval between the electrode pins 111A to 111C and an interval between the electrode pins 111D to 111F.

In the optical transmitter-receiver module 101, a laser diode (LD) 113 as the light emitting element, a photo diode (PD) 114 as the light receiving element, a sub mount 115A for positioning the LD 113 and the PD 114 and an optical waveguide 116 having a lower end surface optically coupled with the LD 113 and the PD 114 and an IC 121 for amplifying an output signal of the PD 114 are mounted on the stem 110A.

The optical transmitter-receiver module 101 includes a metal cap 118, which has a circular opening 118a and is fixed to the stem 110A by electrically conductive adhesive to seal the respective members on the stem 110A, a transparent window 119, which is provided in the cap 118 to cover the opening 118a of the cap 118 from an inner side thereof, a refractive index matching agent 117 arranged between the upper end surface of the optical waveguide 116 and the transparent window 119 and a plurality of bonding wires 120 for connecting the LD 113 and the PD 114 to the electrode pins 111 (111A to 111F).

A metal package for housing the optical parts such as the LD 113 and the PD 114 is constructed with the stem 110A and the cap 118. In order to reduce external noise and/or cross-talk, the stem 110A and the cap 118 are formed of metals such as aluminum, stainless steel or copper alloy.

In the pin holding portion 112A, the left side electrode pin 111A of the electrode pin 111A to 111C for the transmission system is used for power supply, the center electrode pin 111B is used for grounding and the right side electrode pin 111C is used for drive signal. In the pin holding portion 112B, the left side electrode pin 111D of the electrode pin 111D to 111F for receiving system is used for grounding and the center and right electrode pins 111E and 111F are used for output signal.

The LD 113 is a surface type optical element having a light emitting portion 113a for emitting an optical signal on an upper surface thereof and a lower surface thereof to be mounted on the stem 110A. For example, the LD 113 has two electrodes on the upper surface thereof. As the LD 113, a VCSEL having wavelength of 850 nm may be used. Incidentally, the LD 113 may have the electrodes on both the upper and lower surfaces, respectively. In such case, it is possible to directly ground the lower surface electrode through the stem 110A.

The PD 114 is a surface type optical element having a light receiving portion 114a for receiving an optical signal on an upper surface thereof and a lower surface thereof to be mounted on the stem 110A. For example, the PD 114 has two electrodes on the upper surface. As the PD 114, a GaAs PIN photo diode may be used.

The optical waveguide 116 is, for example, a high molecular optical waveguide and can be fabricated by molding core material such as acrylic resin, epoxy resin or polyimide resin to a light guide portion 116a having inverted Y shape and forming a clad of such as fluororesin, which has refractive index smaller than that of the core material, around the core. Such optical waveguide 116 may be fabricated as disclosed in, for example, JP-A-2004-226941. That is, the high molecular optical waveguide is fabricated by filling a recessed portion formed in a surface of a hardened resin mold with a core forming resin such as thermosetting or ultraviolet-ray setting resin, attaching a clad forming film to a surface of the mold, setting the core forming resin, removing the hardened core forming resin from the mold and forming a clad layer on the side of a core forming surface of the clad forming film. Incidentally, the pattern of the light guide portion 116a is not limited to the inverted Y shape and other patterns such as Y shape according to a combination of the optical elements.

The refractive index matching agent 117 is formed of a transparent material having refractive index similar to that of the optical waveguide 116 and the transparent window 119 and, for example, silicone resin or ultraviolet-ray setting adhesive may be used as the transparent material.

The transparent window 119 is formed of a plastics material such as polymethyl methacrylate, polycarbonate or amorphous polyolefin or inorganic glass.

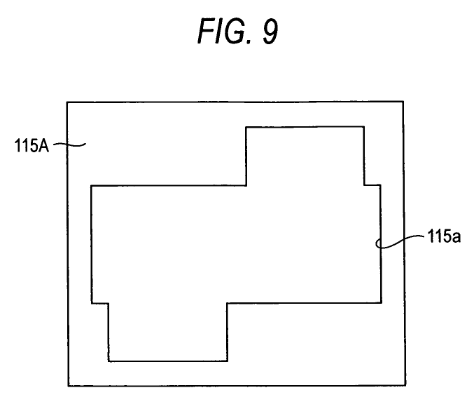

FIG. 9 is a plan view of the sub mount 115A. The sub mount 115A has a through-hole 115a having a shape corresponding to an outer configuration of the LD 113 and the PD 114 and the optical waveguide 116 mounted on the LD 113 and the PD 114. The sub mount 115A may be formed by, for example, resin molding or reactive ion etching (RIE) of silicon material. Incidentally, the sub mount 115A may have through-holes for positioning the LD 113 and the PD 114 and a recessed portion for positioning the lower end surface of the optical waveguide 116. Alternatively, the sub mount 115A may have a recessed portion for positioning the LD 113 and the PD 114 and a recessed portion for positioning the lower end surface of the optical waveguide 116.

(Fabrication Method of the Optical Communication Device)

Now, an example of fabrication method of the optical communication device will be described. The sub mount 115A and the IC 121 are fixed in predetermined positions on the stem 110A, which has the electrode pins 111, by adhesive, the LD 113 and PD 114 are inserted into the through-hole 115a of the sub mount 115A and the mounting surfaces of the LD 113 and PD 114 are fixed on the stem 110A by adhesive.

Next, the electrode pin 111A for power supply is connected to the IC 121 and the electrode pins 111B and 111C for transmission system are connected to the LD 113 by bonding wires 120. Further, the PD 114 and the electrode pins 111D to 111F for the receiving system are connected to the IC 121 by the bonding wires 120 and then the electrode pin 111D for grounding is connected to the stem 110A by the bonding wire 120. Incidentally, though, in this embodiment, the power for the IC 121 for the receiving system is led out from the electrode pin 111A for the transmission system, probability of mixing noise generated in the transmission system into the receiving system through the power source line is small.

Next, the optical waveguide 116 is inserted into the through-hole 115a of the sub mount 115A such that the lower end surface of the optical waveguide 116 contacts with the LD 113 and PD 114 and is fixed to the sub mount 115A by adhesive. The lower end surface of the light guide portion 116a is optically coupled with the light emitting portion 113a of the LD 113 and the light receiving portion 114a of the PD 114.

Next, the upper end surface of the light guide portion 116a of the optical waveguide 116 is painted with the refractive index matching agent 117 and the cap 118 having the transparent window 119 is fixed to the stem 110A by electrically conductive adhesive. The upper end surface of the light guide portion 116a is optically coupled with the transparent window 119 through the refractive index matching agent 117.

The optical transmitter-receiver module 101 thus fabricated is mounted on the circuit board 150 by inserting the electrode pins 111A to 111F of the optical transmitting-receiving module 101 into pin-holes formed in the circuit board 150. Next, the housing 131 having the lens portion 131a and the optical fiber holding portion 131b is put on the cap 118 and the optical fiber 130 is held by the optical fiber holding portion 131b. After the housing 131 is positioned, the housing 131 is fixed to the cap 118 by such as epoxy resin. Thus, the optical communication device is fabricated.

(Operation of the Optical Communication Device)

Next, an operation of the optical communication device will be described. When an optical signal is transmitted through the optical fiber 130, the optical signal is guided to the upper surface of the light guide portion 116a of the optical waveguide 116 through the lens portion 131a, the transparent window 119 and the refractive index matching agent 117. The optical signal from the light guide portion 116a is guided to the light receiving portion 114a of the PD 114. The PD 114 converts the optical signal from the light guide portion 116a into an electric signal and the electric signal is supplied to the IC 121. The IC 121 amplifies the electric signal from the PD 114 and supplies it to the circuit board 150 through the terminal pins 111E and 111F of the receiving system.

On the other hand, when the drive signal of the LD 113 is inputted from the circuit board 50 to the LD 113 through the terminal pin 111C of the transmitting system, the light emitting portion 113a of the LD 113 emits optical signal. The optical signal is incident on the lower end surface of the light guide portion 116a of the optical waveguide 116 and then passed through a branch portion of the light guide portion 116a and inputted to the optical fiber 130 through the refractive index matching agent 117, the transparent window 119 and the lens portion 131a. Thus, the one core interactive communication is performed through one core.

### Advantage of the Fourth Embodiment

According to the fourth embodiment, it is possible to restrict occurrence of cross-talk between the transmitting system and the receiving system since the electrode pins 111 of the optical transmitting-receiving module 101 for the transmitting system and the electrode pins 111 for the receiving system are arranged in the different positions through the linear dividing line B and the electrode pins 111A to 111C of the transmitting system and the electrode pins 111D to 111F of the receiving system are made longer than the minimum pin distance. Further, it is possible to cut out external noise and cross-talk since the LD 113, the PD 114 and the IC 121 are housed in the metal package. Further, the downsizing of the optical waveguide 116 is possible since the LD 113 and the PD 114 are housed in the same package.

### Fifth Embodiment

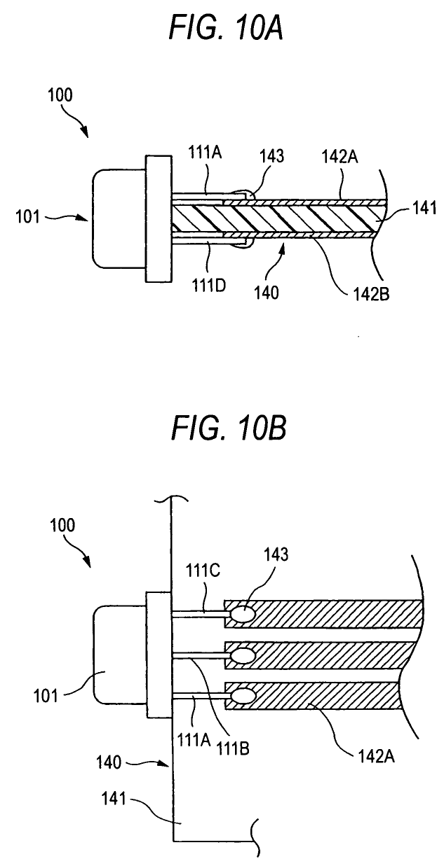

FIGS. 10A and 10B show an optical communication device according to a fifth embodiment of the present invention, in which FIG. 10A is a front view thereof and FIG. 10B is a plan view thereof.

The optical communication device 100 includes the optical transmitter-receiver module 101 according to the fourth embodiment and a circuit board 140 mounted with the optical transmitting-receiving module 101 attached in a side surface direction of the circuit board 140.

The circuit board 140 includes a substrate 141 formed of an insulating material, a first conductive pattern 142A formed on a surface (first surface) of the substrate 141, a second conductive pattern 142B formed on the other surface (second surface) of the substrate 141 and various electronic parts such as a driving IC for driving the LD 113, a capacitor and resistors, which are not shown. Thickness of the substrate 141 is substantially equal to a distance between the electrode pins 111A to 111C on the side of the pin holding portion 112A of the optical transmitting-receiving module 101 and the electrode pins 111D to 111F on the side of the pin holding portion 112B thereof.

In order to mount the optical transmitter-receiver module 101 on the circuit board 140, the electrode pins 111A to 111C of the transmitting system and the electrode pins 111D to 111F of the receiving system are put overlapped on the first conductive patterns 142A and the second conductive pattern 142B, respectively, as shown in FIG. 10B and the circuit board 140 is inserted in between the first and second conductive patterns. Thereafter, the top end portions of the electrode pins 111A to 111F are soldered to predetermined positions of the first and second conductive patterns 142A and 142B as shown in FIGS. 10A and 10B.

### Advantage of the Fifth Embodiment

According to the fifth embodiment, it is possible to reduce cross-talk between the transmission system and the receiving system without forming complicated conductive patterns since the electrode pins 111 of the optical transmitting-receiving module 101 for the transmission system and for the receiving system are connected to the conductive pattern 142A formed on one surface of the circuit board 140 and the conductive pattern 142B formed on the other surface thereof, respectively. Further, it is possible to further reduce cross-talk since the electrode pins 111B and 111D for the grounding are connected to the grounding patterns of the circuit board 140, respectively. Incidentally, it may be possible to construct the circuit board 140 with a multi layer circuit board and provide an intermediary layer as a shield layer. In such case, cross-talk will be further reduced.

### Sixth Embodiment

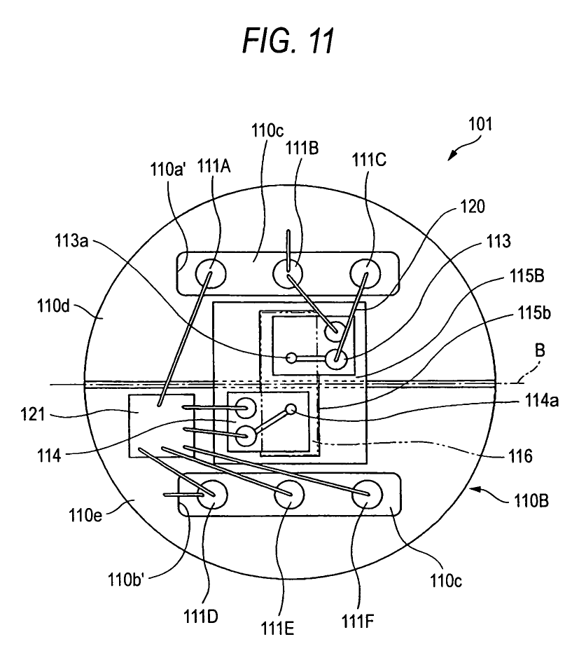

FIG. 11 shows the optical transmitter-receiver module according to a sixth embodiment of the present invention. The sixth embodiment differs from the forth embodiment in that a stem 110B is used instead of the stem 110A of the fourth embodiment and the light emitting portion 113a of the LD 113 and the light receiving portion 114a of the PD 114 are arranged on a line orthogonal to the arranging direction of the electrode pins 111A to 111C and 111D to 111F. The stem 110B in the sixth embodiment includes a resin body portion 110c on an upper surface of which a transmitting side metal region 110d as the first region defined by the dividing line B and a receiving side metal region 110e as the second region insulated from the transmitting side metal region 110d are formed.

In the sixth embodiment, the optical waveguide 116 is set in a position rotated by 90 degree with respect to that in the fourth embodiment. Further, the electrode pin 111B for the grounding in the transmission system is connected to the transmission side metal region 110d by a bonding wire 120.

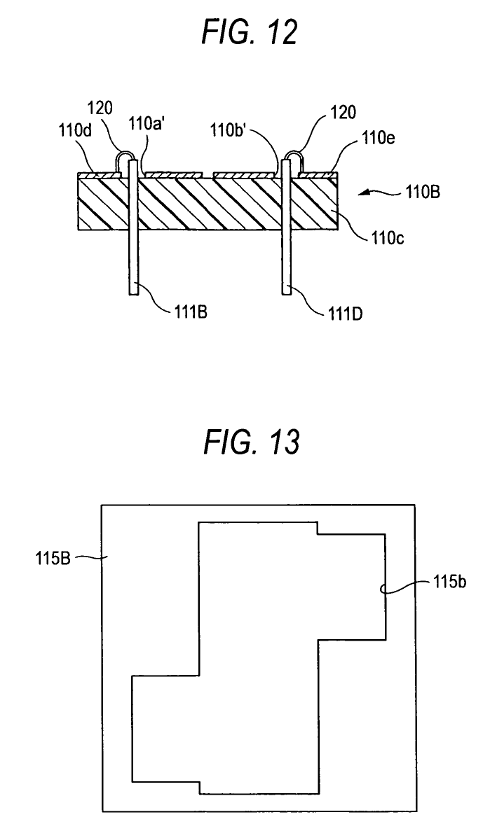

FIG. 12 is a cross sectional view showing a structure of the stem 110B. The transmission side metal region 110d and the receiving side metal region 10e are formed on the resin body portion 110c of the stem 110B. As shown in FIGS. 11 and 12, the transmission side metal region 110d has an opening 110a′ and the receiving side metal region 110e has an opening 110b′ as shown in FIGS. 11 and 12.

FIG. 13 shows a sub mount 115B of the sixth embodiment. The sub mount 115B is formed of a similar material to that of the sub mount 115A of the fourth embodiment and has a through-hole 115b corresponding to the LD 113 and the PD 114 on which the optical waveguide 116 is mounted.

According to the sixth embodiment, the grounding electrode pin 111B of the transmission system and the grounding electrode pin 111D of the receiving system are connected to the insulated transmission side metal region 110d and the receiving side metal region 110e, respectively. Therefore, it is possible to further reduce the cross-talk.

Incidentally, the LD 113 having electrodes on the upper and lower surfaces of the circuit board may be used. In such case, the electrode on the lower surface of the circuit board may be grounded directly to the transmission side metal region 10d.

### Seventh Embodiment

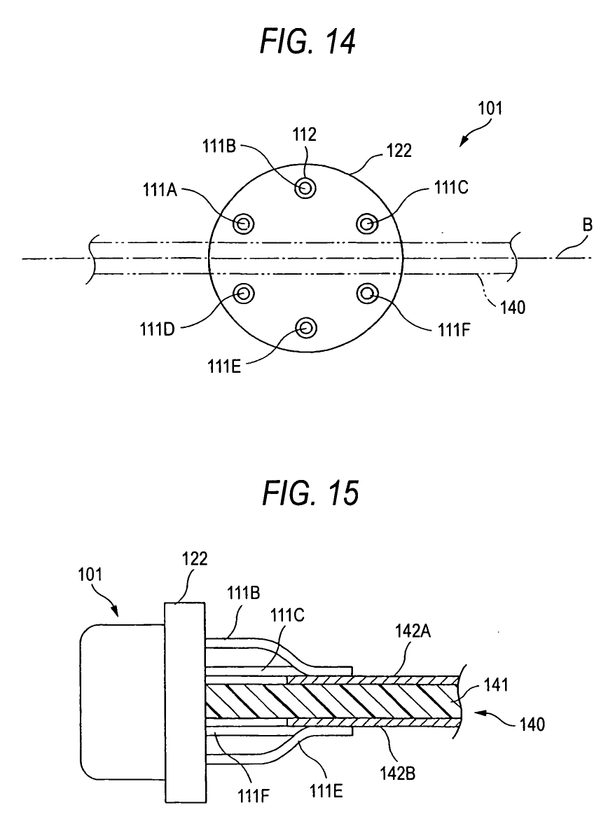

FIG. 14 shows an optical transmitter-receiver module according to a seventh embodiment of the present invention and FIG. 15 shows a state in which the optical transmitter-receiver module shown in FIG. 14 is mounted on the circuit board. Incidentally, FIG. 14 shows a lower surface of the stem. The seventh embodiment is similar to the fourth embodiment except that the electrode pins 111A to 111F in the fourth embodiment shown in FIG. 7 are grouped to the transmission system and the receiving system, divided by the dividing line B on a circular metal stem 122 and the electrode pins 111A to 111F are arranged at intervals of 60 degree by pin holding portions 112 formed of insulating material.

In order to mount this optical transmitter-receiver module 101 on the circuit board 140, the center electrode pin 111B of the electrode pins 111A to 111C of the transmission system and the center electrode pin 111E of the electrode pins 111D to 111F of the receiving system are bent so that a distance between top end portions of the electrode pins 111A to 111C of the transmission system and top end portions of the electrode pins 111D to 111F of the receiving system becomes substantially equal to the thickness of the circuit board 140, as shown in FIG. 15. Incidentally, the electrode pins 111B and 111E may be preliminarily bent.

Next, the circuit board 140 is inserted into between the electrode pins 111A to 111C of the transmission system and the electrode pins 111D to 111F of the receiving system while overlapping the electrode pins 111A to 111c on the first conductive pattern 142A and the electrode pins 111D to 111F on the second conductive pattern 42B and the top end portions of the electrode pins 111A to 111F are soldered to the respective conductive patterns.

According to the seventh embodiment, even when a plurality of electrode pins 111 are arranged concentrically on the stem 122, it is possible to reduce cross-talk by grouping the electrode pins 111 to the transmission system and the receiving system and connecting the them to the electrode patterns 142A and 142B formed on the opposite surfaces of the circuit board 140, respectively.

### Eighth Embodiment

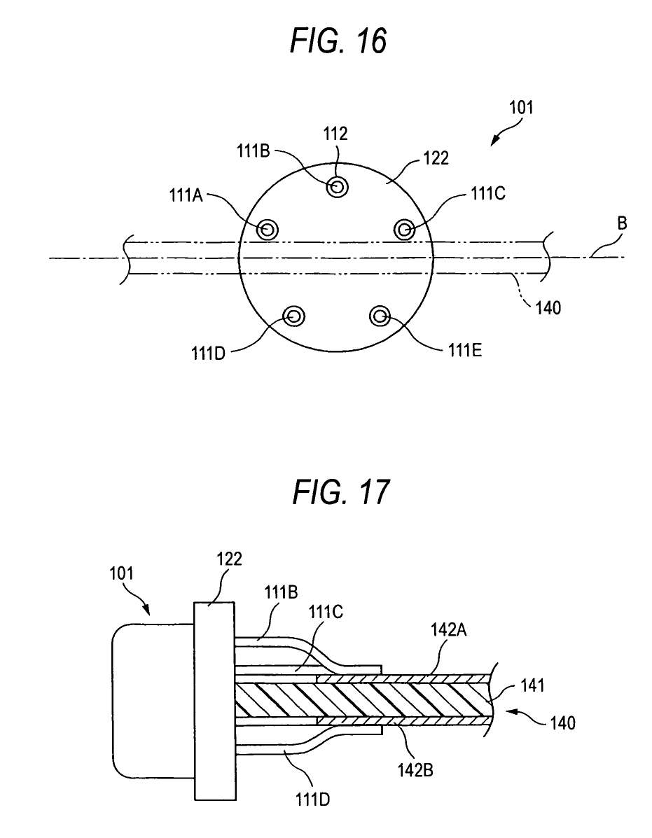

FIG. 16 shows an optical transmitter-receiver module according to an eighth embodiment of the present invention and FIG. 17 shows a state in which the optical transmitting-receiving module shown in FIG. 16 is mounted on a circuit board. Incidentally, FIG. 16 is a lower surface side view of the stem. The eighth embodiment differs from the seventh embodiment shown in FIG. 14 in that the electrode pin 111E in the seventh embodiment is removed and the remaining five electrode pins 111A to 111D and 111F are arranged concentrically. Incidentally, in the eighth embodiment, the electrode pins 111A to 111C are for the transmitting system and the electrode pins 111D and 111F are for the receiving system. It is of course possible to use the electrode pins 111A to 111C are for the receiving system and the electrode pins 111D and 111F are for the transmission system.

In order to mount this optical transmitter-receiver module 101 on the circuit board 140, the center electrode pin 111B of the electrode pins 111A to 111C of the transmission system is bent and the electrode pins 111D and 111F of the receiving system are bent so that a distance between top end portions of the electrode pins 111A to 111C of the transmission system and top end portions of the electrode pins 111D and 111F of the receiving system becomes substantially equal to the thickness of the circuit board 140, as shown in FIG. 17. Incidentally, the electrode pins 111B, 111D and 111F may be preliminarily bent.

Next, the circuit board 140 is inserted into between the electrode pins 111A to 111C of the transmission system and the electrode pins 111D and 111F of the receiving system while overlapping the electrode pins 111A to 111C on the first conductive pattern 142A and the electrode pins 111D and 111F on the second conductive pattern 142B and the top end portions of the electrode pins 111A to 111D and 111F are soldered to the respective conductive patterns.

According to the eighth embodiment, even when the odd number of electrode pins 111 are arranged on the stem 122 concentrically, it is possible to reduce cross-talk by grouping the electrode pins 111 to the transmission system and the receiving system and connecting them to the conductive patterns 142A and 142B on the circuit board 140, respectively.

### Other Embodiments

Incidentally, the present invention is not limited to the described embodiments. The described embodiments may be variously modified within the scope of the present invention. Further, the constructive components of the described embodiments may be arbitrarily combined within the scope of the present invention.

Though the cases where the number of the electrode pins 111 is five and is six are described, the number of the electrode pins may be four or seven or more.

Though, in the described embodiments, the LD 113, the PD 114 and the amplifying IC are housed in the package, it is possible to arrange the amplifying IC on the circuit board other than in the package. Further, the LD 113, the PD 114 and a driving IC for driving the LD 113 may be housed in the package or the LD 113, the PD 114, the driving IC and the amplifying IC may be housed in the package.

As was described, according to an aspect of the invention, a distance between the terminal related to the light emitting element and the terminal related to the light receiving element is preferably larger than a minimum distance between terminals of the plurality of the terminals. Cross-talk between the transmitting system and the receiving system hardly occurs by arranging the terminals related to the light emitting element and the terminals related to the light receiving element separately and making the distance between the terminals related to the light emitting element and the terminals related to the light receiving element large.

Incidentally, it is possible to restrict cross-talk between the transmitting system and the receiving system by providing an insulator or a shield plate between the terminal related to the light emitting element and the terminal related to the light receiving element even when the distance between the terminal related to the light emitting element and the terminal related to the light receiving element is shorter than a minimum distance between the plurality of the terminals.

At least top end portions of the terminals related to the light emitting element and the terminals related to the light emitting element are arranged in different lines separated from each other by a predetermined distance.

The predetermined distance may correspond to thickness of the circuit board to which the plurality of the terminals are connected. With such construction, when the optical transmitter-receiver module is mounted on the circuit board to cover the side surface portion of the circuit board, it is possible to position the circuit board between the terminals related to the light emitting element and the terminals related to the light emitting element, which are arranged in the different lines. Therefore, occurrence of cross-talk can be further restricted.

The terminals related to the light emitting element and the terminals related to the light emitting element may include grounding terminals respectively. By separating the grounding terminal of the transmitting system from that of the receiving system, occurrence of cross-talk can be further restricted.

The package may include a metal portion, on which the light emitting element and the light receiving element are mounted. In such case, it is possible to reduce noise and/or cross-talk from a side opposite to a surface of the metal portion on which the light emitting element and the light receiving element are mounted.

The metal portion may include a first metal region and a second metal region, which are insulated from each other. The light emitting element may be mounted on the first metal region and the light receiving element may be mounted on the second metal region. For example, by grounding the first and second metal regions separately, it becomes possible to restrict cross-talk between the transmitting side and the receiving side.

The terminals related to the light emitting element may be arranged in the first region through an insulating member and the terminals related to the light receiving element may be arranged in the second region through an insulating member.

The terminals related to the light emitting element and the light receiving element may have grounding terminals, respectively. The grounding terminal related to the light emitting element is electrically connected to the first region and the grounding terminal related to the light receiving element is electrically connected to the second region. By grounding the first and second regions through the grounding terminals, respectively, it becomes possible to restrict cross-talk between the transmitting side and the receiving side.

The package may include a metal portion, on which parts are mounted, and a metal cap mounted on the metal portion for covering the light emitting element and the light receiving element. The metal cap has an optically transparent window for transmitting optical signal. With such construction, it is possible to reduce external noise and cross-talk.

On the metal portion of the package, an optical waveguide, which transmits an optical transmitting signal through an optical transmission medium and guides an optical signal transmitted through the optical transmission medium to the light receiving element, may be mounted in addition to the light emitting element and the light receiving element, so that a one core interactive communication is possible through the optical transmission medium. By using the optical waveguide as the optical coupling portion, the downsizing of the optical transmitting-receiving module can be realized.

By arranging a refractive index matching agent between the optical waveguide and the transparent window, the optical coupling efficiency is improved.

In addition to the light emitting element and the light receiving element, an amplifying IC for amplifying an output signal from the light receiving element may be mounted on the metal portion of the package. With such construction, it is possible to prevent noise from being mixed in the signal line between the light receiving element and the amplifying IC and following the amplifying IC.

In addition to the light emitting element and the light receiving element, a drive IC for driving the light emitting element may be mounted on the metal portion of the package.

The terminals related to the light emitting element and the terminals related to the light receiving element may include grounding terminals, respectively, and the first and second conductive patterns have grounding patterns connected to the respective grounding terminals. By separating the grounding terminals for the transmitting system and the receiving system, occurrence of cross-talk is further restricted.

Thickness of the circuit board may be smaller than the distance between the terminal related to the light emitting element and the terminal related to the light receiving element.

The entire disclosure of Japanese Patent Applications No. 2005-257581 filed on Sep. 6, 2005 and No. 2005-264082 filed on Sep. 12, 2005 including specifications, claims, drawings and abstracts is incorporated herein by reference in its entirety.

What is claimed is:

1. An optical transmitter-receiver comprising:
an optical module including a metal package housing at least a light receiving element and a light emitting element;
a circuit board for transmitting/receiving an electric signal with respect to the optical module;
a first wiring for connecting a side of the light receiving element to the circuit board;
a second wiring for connecting a side of the light emitting element to the circuit board; and
a shield member for shielding at least the first wiring.

2. The optical transmitter-receiver as claimed in claim 1, wherein the shield member shields the first wiring and the second wiring, separately.

3. The optical transmitter-receiver as claimed in claim 1, wherein the optical module includes an amplifier for amplifying an output signal of the light receiving element and the first wiring connects the amplifier to the circuit board.

4. The optical transmitter-receiver as claimed in claim 1, wherein the first wiring and the second wiring are an electrode pin led out from the metal package on the side of the light emitting element and an electrode pin led out from the metal package on the side of the light receiving element, respectively.

5. The optical transmitter-receiver as claimed in claim 4, wherein the optical module is mounted on a side portion of the circuit board and the electrode pin on the side of the light emitting element and the electrode pin on the side of the light receiving element are connected to conductive patterns formed on one of opposite surfaces of the circuit board and the other surface thereof, respectively.

6. The optical transmitter-receiver as claimed in claim 1, wherein the shield member covers the wirings while being connected to the metal package and a grounding pad provided on the circuit board.

7. The optical transmitter-receiver as claimed in claim 6, wherein the shield member is a metal sheet.

8. The optical transmitter-receiver as claimed in claim 6, wherein the shield member is a metal foil and an insulating member is provided between the shield member and the wirings.

9. The optical transmitter-receiver as claimed in claim 8, wherein the metal package of the optical module includes a grounding electrode pin connected to the grounding pad provided on the circuit board and the metal foil is connected to the grounding electrode pin.

10. The optical transmitter-receiver as claimed in claim 1, wherein the optical module includes an amplifier for amplifying an output signal of the light receiving element, the light receiving element is positioned by a sub mount formed of an insulating material, the amplifier is connected to the light receiving element through a bonding wire and the sub mount includes an impedance reducing member provided below the boding wire.

11. The optical transmitter-receiver as claimed in claim 10, wherein the impedance reducing member is a metal member grounded by the metal package and having insulated surfaces.

12. The optical transmitter-receiver as claimed in claim 1, wherein the first and second wirings are formed on a flexible substrate.

13. The optical transmitter-receiver as claimed in claim 12, wherein a conductive pattern on the side of the light receiving element and a conductive pattern on the side of the light emitting element are led out from the optical module in different directions.

14. The optical transmitter-receiver as claimed in claim 12, wherein the flexible substrate has a micro strip line structure.
